(19) United States
(12) Patent Application Publication
(10) Pub. No.: US 2016/0098973 A1
(43) Pub. Date: Apr. 7, 2016

(54) METHOD FOR IMAGE DISPLAY AND IMAGE CONTROL MODULE USING THE SAME

(71) Applicant: ILI TECHNOLOGY CORPORATION, Jhubei City (TW)

(72) Inventors: Shao-Sheng YANG, Kaohsiung City (TW); Tzu-Chin LIU, Taoyuan City (TW); Ming-Yu TSAI, Kaohsiung City (TW)

(21) Appl. No.: 14/738,101

(22) Filed: Jun. 12, 2015

(30) Foreign Application Priority Data
Oct. 1, 2014 (TW) 103134208

(51) Int. Cl. G09G 5/10

(52) U.S. Cl. CPC G09G 5/10; G09G 2360/144

(57) ABSTRACT

A method for image display of a mobile device includes: determining a backlight intensity parameter according to a user-defined backlight brightness and an ambient light intensity value when the ambient light intensity value is greater than a predetermined threshold value; and providing backlight to a display module of the mobile device according to the backlight intensity parameter.

### CROSS-REFERENCE TO RELATED APPLICATION

This application claims priority to Taiwanese Application No. 103134208, filed on Oct. 1, 2014.

### FIELD

The disclosure relates to a method for image display and a control module, and more particularly to an image display method that may enhances image readability under sunlight, and an image control module using the same.

### BACKGROUND

Mobile devices, such as smartphones, tablet computers, etc., have become popular with the development of information technology and mobile communication, and bring convenience to life. However, in an indoor to outdoor transition, excessive hard light (such as sunlight) outdoors may cause the user to feel that an image, which is clearly visible indoors, becomes too dark to be clearly seen.

Screen brightness of most mobile devices may be manually adjustable via a built-in application or a button. As an example, a user may adjust screen brightness to be higher in an outdoor environment. However, manual operation is inconvenient for the user and has limited effects.

### SUMMARY

Therefore, an object of the present disclosure is to provide a method for image display that may enhance image readability under sunlight.

According to one aspect of the present disclosure, a method for image display of a mobile device is provided. The mobile device includes a light sensing module for sensing ambient light to generate an ambient light intensity value, a backlight module, a display module for image display, and an image control module, and has a display brightness value that indicates a user-defined brightness of the backlight module.

The method includes: determining, by the image control module, a target image gain value according to the ambient light intensity value and a predetermined reference gain value when the ambient light intensity value is greater than the predetermined threshold value; and displaying, by the display module, an image according to the target image gain value with the backlight module providing the backlight.

Another object of the present disclosure is to provide an image control module that may enhance image readability under sunlight.

According to another aspect of the present disclosure, an image control module for use in a mobile device is provided. The mobile device includes a light sensing module for sensing ambient light to provide an ambient light intensity value, a display module for image display, a backlight module for providing backlight to the display module, and has a display brightness value that indicates a user-defined brightness of the backlight module.

The image control module includes a determining unit and an image gain computation unit.

The determining unit is to be coupled to the light sensing module for receiving the ambient light intensity value therefrom, and is configured to generate a control signal that indicates the ambient light intensity value upon determining that the ambient light intensity value is greater than a predetermined threshold value.

The image gain computation unit is coupled to the determining unit for receiving the control signal therefrom, and configured to generate a target image gain value according to a predetermined reference gain value and the ambient light intensity value that is indicated by the control signal, and to output to the display module the target image gain value in accordance with which the display module displays an image.

### BRIEF DESCRIPTION OF THE DRAWINGS

Other features and advantages of the present disclosure will become apparent in the following detailed description of an embodiment with reference to the accompanying drawings, of which:

FIG. 1 is a block diagram to illustrate an embodiment of a mobile device according to the present disclosure;

FIG. 2 is a flow chart to illustrate steps of a method for image display according to the present disclosure;

FIG. 3 is a plot to illustrate a relationship between ambient light intensity and a target image gain value in one application;

FIG. 4 is a plot to illustrate a relationship between ambient light intensity and the target image gain value in another application;

FIGS. 5A to 5C respectively show readability of an image under different ambient light intensities without implementing the image display method of the present disclosure; and

FIGS. 6A to 6C respectively show readability of the image under different ambient light intensities with implementation of the embodiment of the image display method.

### DETAILED DESCRIPTION

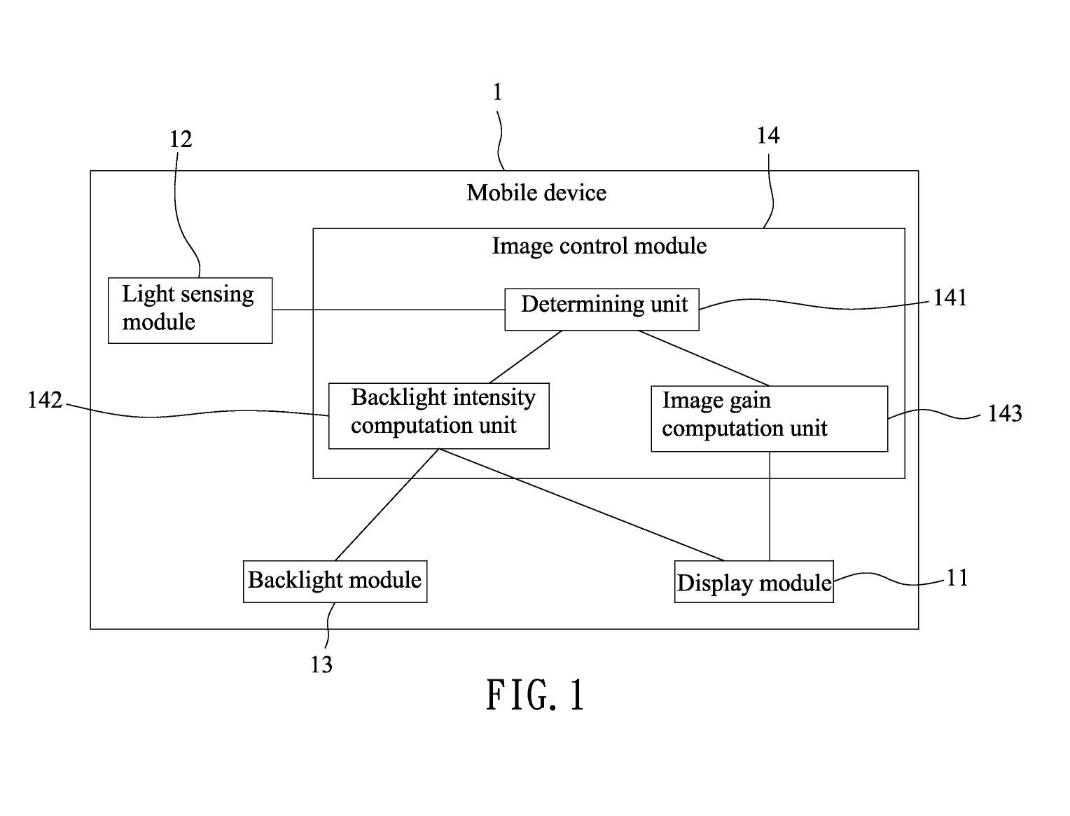

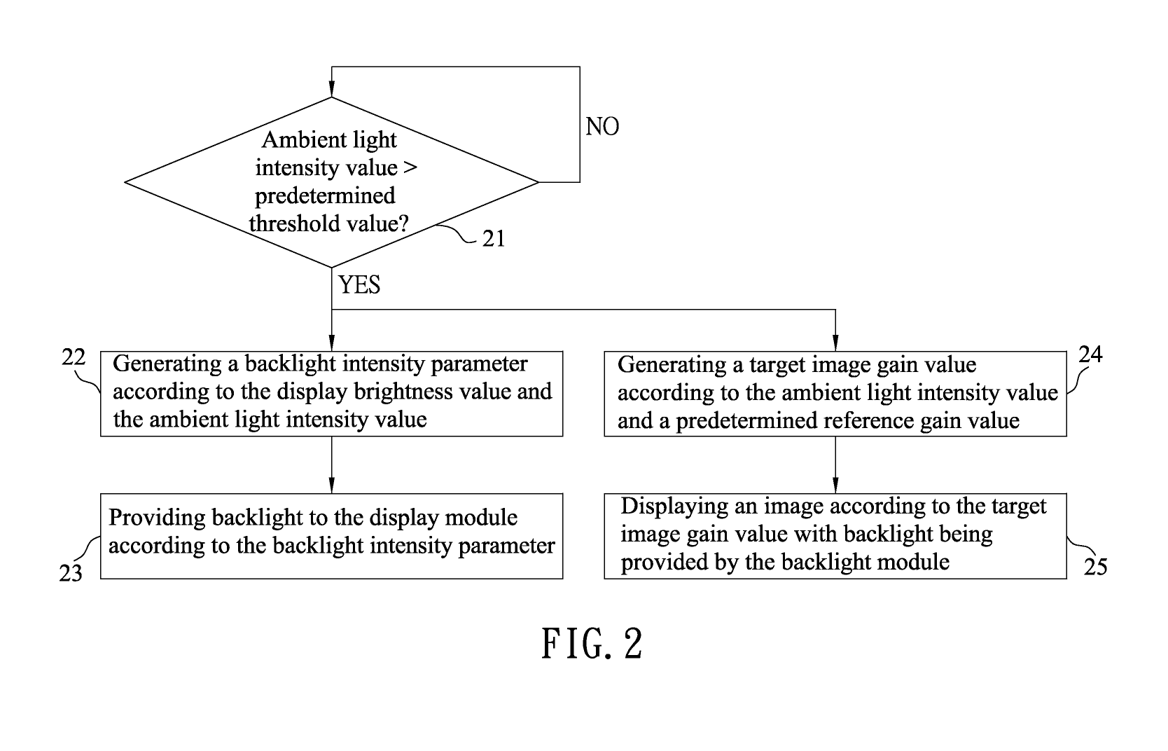

Referring to FIGS. 1 and 2, the embodiment of the image display method for enhancing image readability under sunlight according to this disclosure is adapted to be implemented in a mobile device 1. In this embodiment, the mobile device 1, which may be a smartphone or a tablet computer, includes a display module 11, a light sensing module 12, a backlight module 13 and an image control module 14.

In this embodiment, the display module 11 has a display brightness value indicating a user-defined brightness of the mobile device 1. The display brightness value is user-adjustable via a built-in application or a button (not shown) of the mobile device 1. The light sensing module 12 senses ambient light of an environment in which the mobile device 1 is located so as to generate an ambient light intensity value. The backlight module 13 provides backlight for the display module 11.

The image control module 14 includes a determining unit 141, a backlight intensity computation unit 142 and an image gain computation unit 143. In this embodiment, the determining unit 141 is coupled to the light sensing module 12, the backlight intensity computation unit 142 and the image gain computation unit 143. The backlight intensity computation unit 142 is further coupled to the display module 11 and the backlight module 13. The image gain computation unit 143 is further coupled to the display module 11.

Referring to FIG. 2, the embodiment of the image display method according to this disclosure includes steps 21 to 25.

In step 21, the determining unit 141 receives the ambient light intensity value from the light sensing module 12, determines whether or not the ambient light intensity value is greater than a predetermined threshold value, and generates a control signal indicating the ambient light intensity value upon determining that the ambient light intensity value is greater than the predetermined threshold value. In one embodiment, the predetermined threshold value is set to be an illuminance that may be sensed under an ordinary outdoor environment, typically 5000 lux.

The flow goes to steps 22 and 24 when the determination made in step 21 is affirmative, and goes back to step 21 when otherwise. In step 22, the backlight intensity computation unit 142 receives the control signal from the determining unit 141, receives the display brightness value from the display module 11, and generates a backlight intensity parameter according to the display brightness value and the ambient light intensity value indicated by the control signal.

In one embodiment, the backlight intensity computation unit 142 determines the backlight intensity parameter by: performing normalization calculation on the ambient light intensity value indicated by the control signal to obtain a first normalized value ranging between 0% and 100% (e.g., with a maximum sensible light intensity of the light sensing module 12 represented by 100%); performing normalization calculation on the display brightness value to obtain a second normalized value ranging between 0% and 100% (e.g., with a maximum display brightness value represented by 100%); and selecting a greater one of the first and second normalized values to serve as the backlight intensity parameter.

In one embodiment, when the determining unit 141 determines that the ambient light intensity value is greater than the predetermined threshold value, the backlight intensity computation unit 142 sets the backlight intensity parameter to maximum, i.e., 100%.

After step 22, the flow goes to step 23, where the backlight unit 13 receives the backlight intensity parameter from the backlight intensity computation unit 142, and provides the backlight with an intensity thereof set according to the backlight intensity parameter.

In step 24, the image gain computation unit 143 receives the control signal from the determining unit 141, and computes a target image gain value according to a predetermined reference gain value and the ambient light intensity value indicated by the control signal.

The predetermined reference gain value corresponds to a predetermined reference light intensity value. In one embodiment, the predetermined reference light intensity value is set to be the maximum sensible light intensity of the light sensing module 12, typically 100000 lux. In some embodiments, the predetermined reference gain value ranges between 5 and 10. Note that the image gain value herein refers to brightness gain of images.

In one embodiment, the image gain computation unit 143 computes the target image gain value according to:

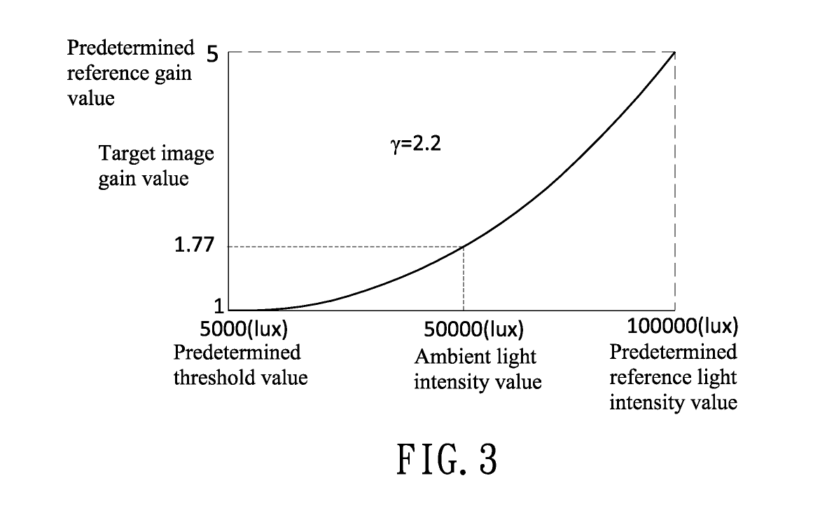

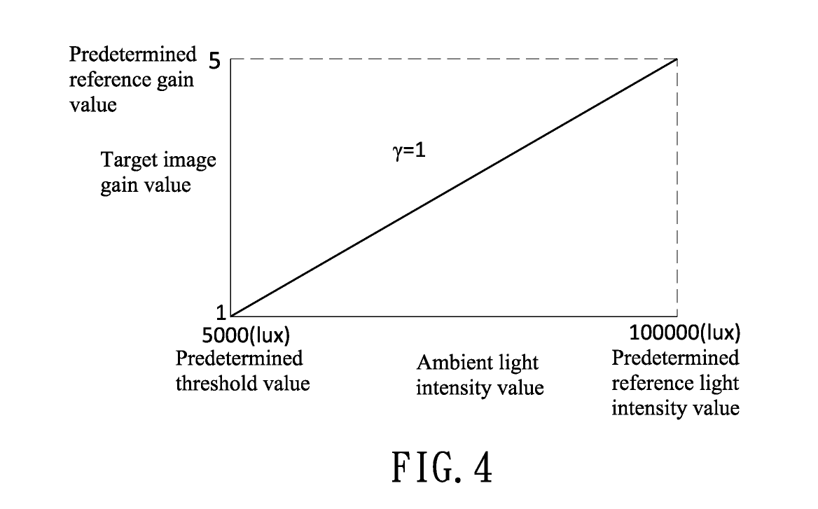

Gₜ=[(Iₐ−Iₜₕ)/(Iᵣ−Iₜₕ)]^{γ}×(Gₚ−1)+1,

where Gₜ represents the target image gain value, Iₐ represents the ambient light intensity value, Iₜₕ represents the predetermined threshold value, Iᵣ represents the predetermined reference light intensity value, γ is a predetermined constant, and Gₚ represents the predetermined reference gain value. In one application, γ may be set to be 2.2 that is used in gamma correction, in which the target image gain value non-linearly increases with increase of the ambient light intensity value, as shown in FIG. 3. In one application, γ may be set to be 1, in which the target image gain value linearly increases with increase of the ambient light intensity value, as shown in FIG. 4.

In one example with γ being 2.2, the predetermined threshold value being 5000 lux, the ambient light intensity value being 50000 lux, the predetermined reference light intensity value being 100000 lux and the predetermined reference gain value being 5, the target image gain value is computed to be 1.77. In other examples in which the ambient light intensity values are respectively 5000 lux and 100000 lux while other parameters are the same as above, the target image gain values are computed to be 1 and 5, respectively.

Following step 24, in step 25, the display module 11 receives the target image gain value from the image gain computation unit 143, and displays images according to the target image gain value, with the backlight module 13 providing the backlight according to the backlight intensity parameter.

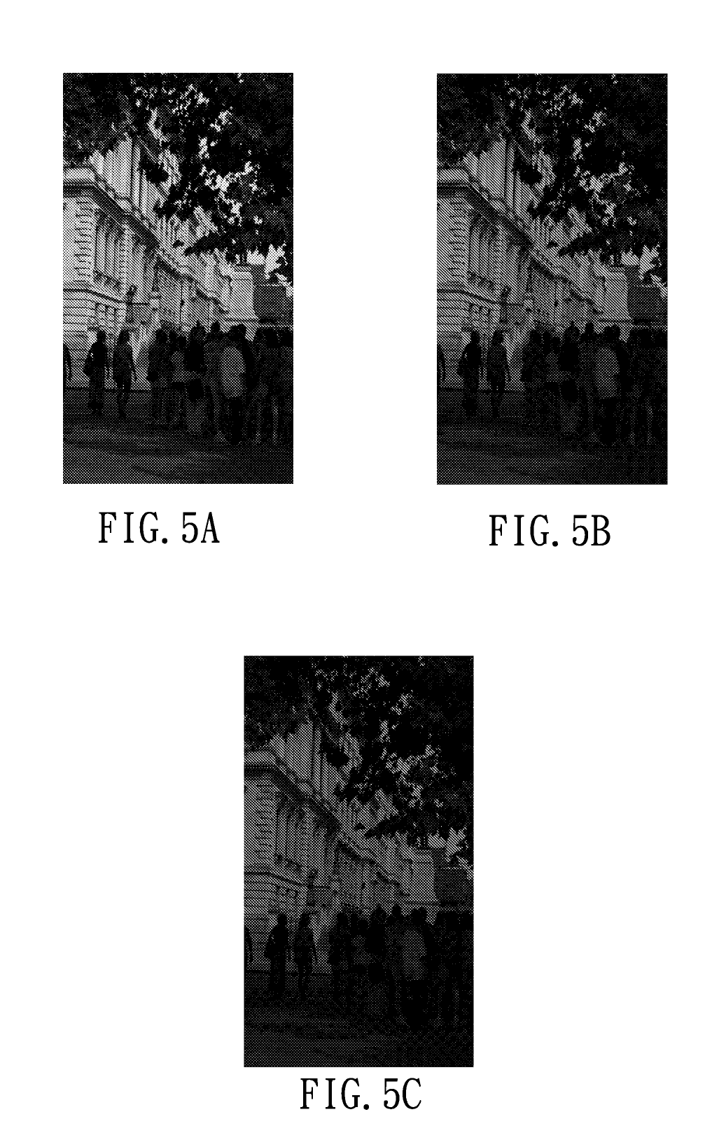

FIGS. 5A, 5B and 5C respectively show readability of an image under different first, second and third ambient light intensities without implementing the image display method of this disclosure, where 5000 lux<the first ambient light intensity<the second ambient light intensity<the third light intensity. It is known that higher ambient light intensity results in lower image readability, where the user's ability to clearly view content of the image is decreased.

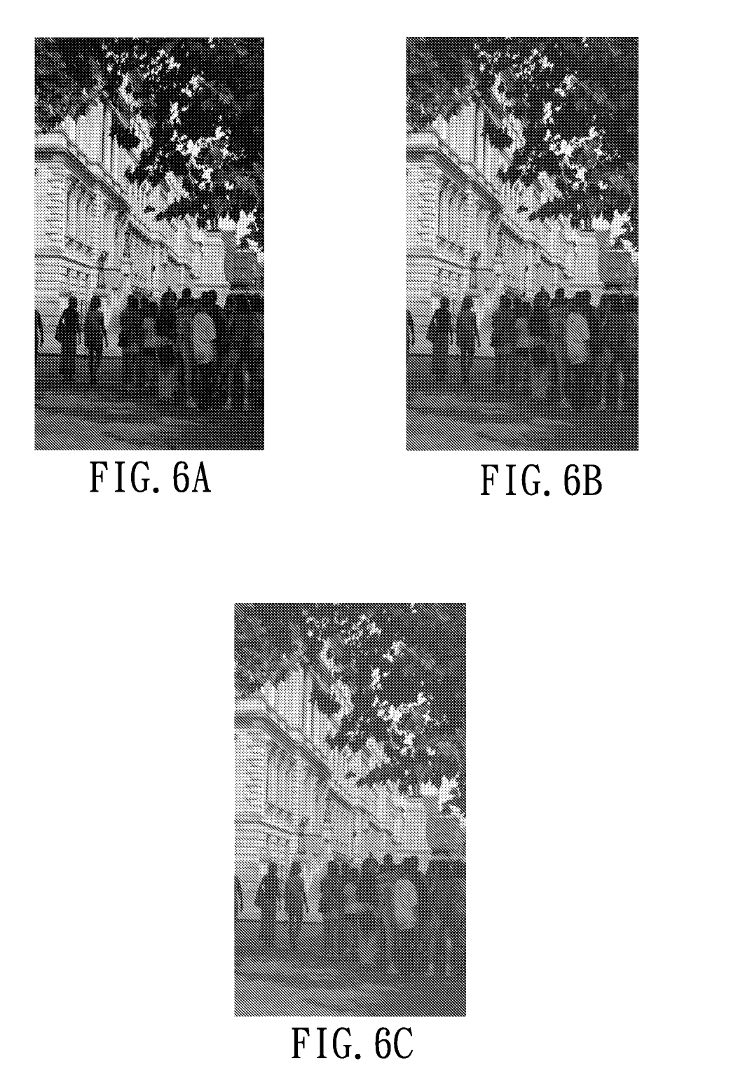

FIGS. 6A, 6B and 6C respectively correspond to FIGS. 5A, 5B and 5C, and show readability of the image displayed by the embodiment of the mobile device 1, which implements the image display method of this disclosure, under the first, second and third ambient light intensities, where γ is 2.2.

It can be seen from FIGS. 5A to 5C and 6A to 6C that the image display method of the present disclosure may, under different ambient light intensities, automatically and properly enhance image readability according to the computed backlight intensity parameter and the target image gain value.

In summary, the image display method and the image control module 14 according to this disclosure are adapted for use in the mobile device 1 to enhance image readability under different lighting conditions, especially under hard light (e.g., sunlight). The backlight unit 13 projects light according to the backlight intensity parameter that is generated according to the display brightness value and the ambient light intensity value. The display module 11 displays images according to the target image gain value that is generated according to the ambient light intensity value and the predetermined reference gain value. As such, outdoor image readability (e.g., under sunlight) is automatically enhanced.

While the present disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A method for image display of a mobile device, the mobile device including a light sensing module for sensing ambient light to generate an ambient light intensity value, a backlight module, a display module for image display, and an image control module, and having a display brightness value that indicates a user-defined brightness of the backlight module, said method comprising:
determining, by the image control module, a target image gain value according to the ambient light intensity value and a predetermined reference gain value when the ambient light intensity value is greater than the predetermined threshold value; and
displaying, by the display module, an image according to the target image gain value with the backlight module providing the backlight.

2. The method according to claim 1, wherein the target image gain value is determined according to:
Gₜ=[(Iₐ−Iₜₕ)/(Iᵣ−Iₜₕ)]^{γ}×(Gₚ−1)+1,
where Gₜ represents the target image gain value, Iₐ represents the ambient light intensity value, Iₜₕ represents the predetermined threshold value, Iᵣ represents a predetermined reference light intensity value, γ is a predetermined constant, and Gₚ represents the predetermined reference gain value.

3. The method according to claim 2, wherein the predetermined reference light intensity value is a maximum sensible light intensity of the light sensing module.

4. The method according to claim 1, further comprising:
determining, by the image control module, a backlight intensity parameter according to the display brightness value and the ambient light intensity value when the ambient light intensity value is greater than a predetermined threshold value; and
providing, by the backlight module, backlight to the display module according to the backlight intensity parameter.

5. The method according to claim 4, wherein the step of determining the backlight intensity parameter includes:
performing normalization calculation on the ambient light intensity value to obtain a first normalized value;
performing normalization calculation on the display brightness value to obtain a second normalized value; and
selecting a greater one of the first and second normalized values to serve as the backlight intensity parameter.

6. An image control module for use in a mobile device, the mobile device including a light sensing module for sensing ambient light to generate an ambient light intensity value, a display module for image display, a backlight module for providing backlight to the display module, and having a display brightness value that indicates a user-defined brightness of the backlight module, said image control module comprising:
a determining unit to be coupled to said light sensing module for receiving the ambient light intensity value therefrom, and configured to generate a control signal that indicates the ambient light intensity value upon determining that the ambient light intensity value is greater than a predetermined threshold value; and
an image gain computation unit coupled to said determining unit for receiving the control signal therefrom, and configured to generate a target image gain value according to a predetermined reference gain value and the ambient light intensity value that is indicated by the control signal, and to output to the display module the target image gain value in accordance with which the display module displays an image.

7. The image control module according to claim 6, wherein said image gain computation unit is configured to generate the target image gain value according to:
Gₜ=[(Iₐ−Iₜₕ)/(Iᵣ−Iₜₕ)]^{γ}×(Gₚ−1)+1,
where Gₜ represents the target image gain value, Iₐ represents the ambient light intensity value, Iₜₕ represents the predetermined threshold value, Iᵣ represents a predetermined reference light intensity value, γ is a predetermined constant, and Gₚ represents the predetermined reference gain value.

8. The image control module according to claim 7, wherein the predetermined reference light intensity value is a maximum sensible light intensity of the light sensing module.

9. The image control module according to claim 6, further comprising a backlight intensity computation unit coupled to said determining unit for receiving the control signal therefrom, to be coupled to the backlight module, and configured to generate a backlight intensity parameter according to the display brightness value and the ambient light intensity value that is indicated by the control signal, and to output to the backlight module the backlight intensity parameter in accordance with which the backlight module provides the backlight.

10. The image control module according to claim 9, wherein said backlight intensity computation unit is configured to perform normalization calculation on the ambient light intensity value to obtain a first normalized value, to perform normalization calculation on the display brightness value to obtain a second normalized value, and to select a greater one of the first and second normalized values to serve as the backlight intensity parameter.
